(19) United States
(12) Patent Application Publication
(10) Pub. No.: US 2013/0323400 A1
(43) Pub. Date: Dec. 5, 2013

(54) Edible Filling and Method Of Making An Edible Filling

(71) Applicant: Pioneer Pet Products, LLC, Cedarburg, WI (US)

(72) Inventors: Scott Repinski, Franklin, WI (US); John M. Lipscomb, Cedarburg, WI (US)

(21) Appl. No.: 13/910,102

(22) Filed: Jun. 4, 2013

Related U.S. Application Data
(60) Provisional application No. 61/655,221, filed on Jun. 4, 2012.

(51) Int. Cl. A23G 3/44

(52) U.S. Cl. CPC A23G 3/44
USPC 426/656

(57) ABSTRACT

An edible filling formed of protein-containing solid particles in a fat-containing carrier having lecithin during wet particle size reduction to emulsify before enough starch is added to absorb excess or free fat-containing carrier when mixed together. One preferred particle size reduction method step employs wet grinding of proteins in a ball mill disposed in a fat containing oil or shortening carrier until substantially all of the proteins have been reduced in size to a particle size of less than 40 microns enabling the reduced size protein particles to remain in suspension in the resultant filling for an extended period of time increasing filling storage or shelf life while also producing a filling of more uniform appearance, texture and taste. Lecithin in excess of what is needed for emulsification is added during filling making to protect proteins and absorb excess water in the filling.

### CROSS REFERENCE

This application claims priority in U.S. Provisional Patent Application No. 61/655,221, filed Jun. 4, 2012 under 35 U.S.C. §119(e), the entirety of which is hereby expressly incorporated herein by reference.

### FIELD

The present invention relates generally to an edible product and more particularly to an edible filling and method of making an edible filling well suited for use as an edible component of a multicomponent edible food product.

### BACKGROUND

While attempts have been made over the years to develop edible fillings, they have suffered from one or more significant disadvantages that have kept them from widespread commercial adoption. For example, denaturing of proteins in a filling can occur, including during co-extrusion, drying and baking, which is extremely undesirable as it can ruin the filling. Quite often, fat in the filling tends to migrate out softening the food product containing the filling which can also adversely affect taste and appearance. This can even happen during storage of the filling prior to co-extrusion which typically results in the filling being rendered unusable.

### SUMMARY

The present invention is directed to an edible product and method of making an edible product that produces an edible product possessing long shelf life, which is heat stable, which has a substantially uniform consistency, texture and appearance, and which can be used as a component in other edible products. A preferred edible product and manufacturing method produces a filling in accordance with the invention that can be co-extruded to form another type of edible product having at least one other component in addition to the filling. Suitable edible products produced in accordance with the present invention can be formulated for human consumption as well as for animal consumption, e.g., pet food, and can even be used to produce fish food.

In a preferred manufacturing method, protein containing solids are mixed with an oil or shortening carrier in a mixer to form a pre-mix in a pre-mixing step. The pre-mix is then processed by a particle size reducer to reduce the size of the particles of the protein containing solids to a desirably small size so the particles will remain in suspension in the filling produced when the filling making method is completed. The pre-mix preferably includes an emulsifier that can be added during protein particle size reduction as it can help provide viscosity control during the protein particle size reduction step to optimize the production rate of particle size reduced pre-mix. A preferred emulsifier is a lecithin, such as preferably a soy lecithin, which is added in amount of between 0.1% by weight and 0.7% by weight and preferably about 0.5% by weight.

Preferred particle size reducers include a ball mill, roll refiner, e.g., a five roll refiner, or a dry grinder that wet grinds, wet refines or wet mills the pre-mix to reduce the size of the particles of the protein containing solids in the pre-mix. Particle size reduction is performed until substantially all of the protein particles in the refined pre-mix have a particle size no greater than 40 microns to produce a filling in accordance with the present invention in which the reduced size protein particles will remain suspended in the filling.

After particle size reduction is performed, the refined pre-mix is transferred to another mixer where additional emulsifier is added and mixed into the refined pre-mix in a final filling mixing step. A preferred emulsifier is a lecithin, such as soy lecithin, which is added to achieve a weight percent of at least 1.5% of the total filling and preferably between about 2% and about 3% by weight lecithin. The lecithin is mixed in the mixer to coat the reduced size protein particles to protect them from moisture, fat migration, and heat, including during co-extrusion of the filling, such as when co-extruded within an edible shell.

After adding the additional lecithin to the refined pre-mix and mixing it in a mixer to coat the reduced size protein particles, starch is added and mixed until it agglomerates and goes into solution absorbing the free or available oil carrier forming a matrix or solution in which the reduced sized protein particles remain suspended in the final filling when this final mixing step is completed. Preferred starches include flour or flours that are unrefined and preferably possess a mesh size of between 50 mesh and 100 mesh with flour mesh size being no larger than 30 mesh. The amount of the starch added is sufficient to absorb substantially all of the free or available oil/shortening carrier so that substantially all of the fat in the filling is held in solution in a manner that prevents fat migration. In a preferred filling formulation and filling making method, enough unrefined flour of a mesh size no less than 30 mesh and having a mesh of between 50 mesh and 100 mesh is added to absorb substantially all of the free or available fat in the final filling mixture when the flour is mixed forming a matrix or suspension in which the reduced size particles of protein will remain suspended and the fat will remain in solution. In a preferred filling formulation and filling making method, the final filling contains no more than 30% of such starch by weight, typically contains between 3% and 25% starch by weight, and frequently ranges between 5% and 15% by weight depending on the type of filling produced and other factors.

One edible product suitable for human consumption can be a savory filling produced in accordance with the present invention that has between 15% and 60% protein, between 25% and 50% fat, and between 3% and 25% starch. One such savory filling has between 15% and 60% particle size reduced protein containing solids, between 25% and 50% fat containing carrier, e.g. oil and/or shortening, and between 3% and 25% starch containing flour. Such savory fillings have no more than 5% lecithin and preferably at least about 1.5% lecithin and no more than about 3% lecithin.

Another edible product suitable for human consumption can be a confectionary filling having between 5% and 30% protein, between 25% and 50% fat, and between 3% and 25% starch with the remainder substantially constituting sugar and lecithin. Where the filling is a confectionary filling, the amount of sugar can vary between 20% and 50% and typically will fall within the range of 25% to 50% by weight. As with savory fillings of the invention, the amount of lecithin in a confectionary filling produced in accordance with the invention will not exceed 5% and will preferably range between about 1.5% lecithin and about 3% lecithin.

One such confectionary filling has between 5% and 30% particle size reduced protein containing solids, between 25% and 50% fat containing carrier, e.g. oil and/or shortening, and between 3% and 25% starch containing flour with the remainder comprising sugar and lecithin. Such confectionary fillings have no more than 5% lecithin and preferably between 1.5% lecithin and 3% lecithin.

### BRIEF DESCRIPTION OF THE DRAWINGS

The drawings illustrate at least one preferred embodiment presently contemplated for carrying out the invention. In the drawings:

FIG. 1A illustrates a first preferred edible product produced by co-extruding an edible filling of the present invention within an outer edible shell;

FIG. 1B illustrates a second preferred edible product produced by co-extruding a filling of the present invention within an outer edible shell;

FIG. 2A is a cross-section of the first co-extruded edible product shown in FIG. 1A taken along line 2A-2A of FIG. 1A showing more clearly the filling surrounded by the shell;

FIG. 2B is a cross-section of the first co-extruded edible product shown in FIG. 1B taken along line 2B-2B of FIG. 1B showing more clearly the filling surrounded by the shell;

FIG. 3 is a flow chart of a method for producing an edible filling in accordance with the present invention.

Before explaining embodiments of the invention in detail, it is to be understood that the invention is not limited in its application to the details of construction and the arrangement of the components set forth in the following description and illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION

The present invention is directed to an edible product that can be co-extruded within an outer shell forming a food product suitable for human or animal consumption. In one preferred embodiment, the edible product is a filling that can be packaged and stored for an extended period of time while remaining stable and suitable for use as a component of a food product that can be produced in a conventional manner, such as by co-extrusion, which can then be packaged and sold in retail channels.

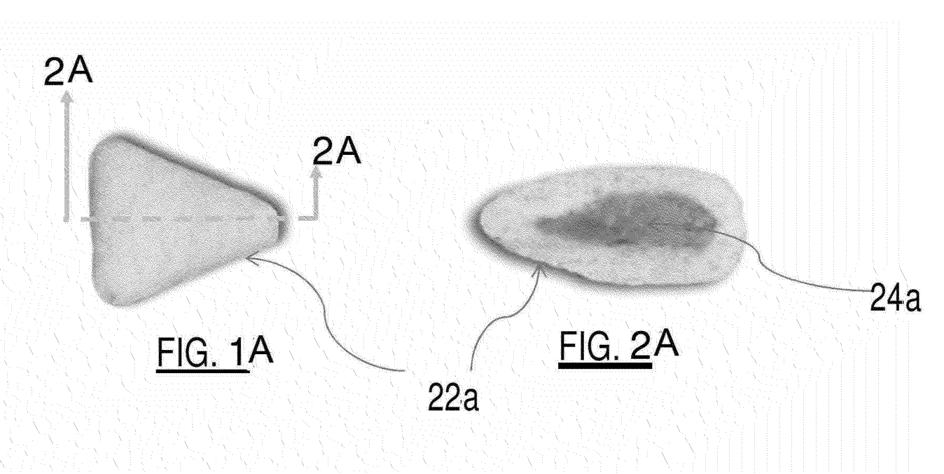

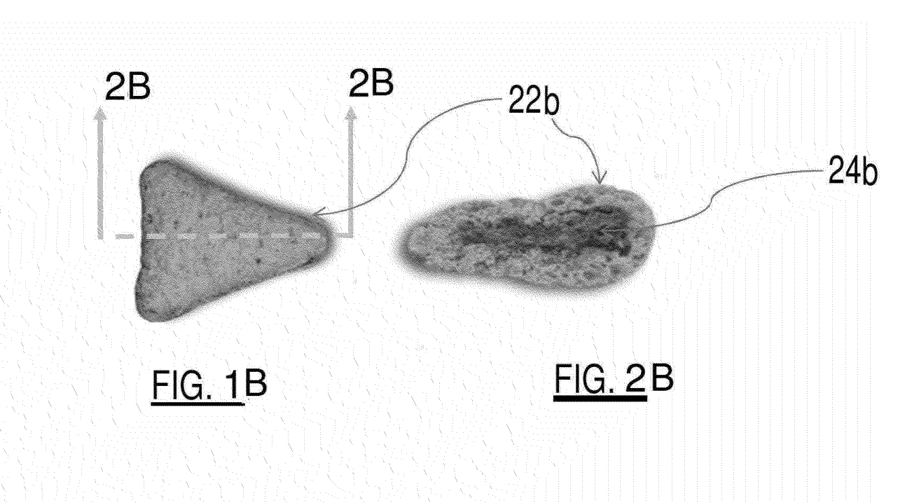

FIGS. 1A, 1B, 2A and 2B illustrate a plurality of pieces of multicomponent food products 20a and 20b respectively having an edible outer shell 22a and 22b that respectively extends at least partially around an edible inner filling 24a and 24b formulated and made in accordance with the present invention. Each piece of food product 20a and 20b can be formed by co-extruding the filling 22a and/or 22b together with the shell 22a and/or 22b into a wide variety of shapes, sizes, colors, textures, surface structures and the like that can be based on the configuration of the tooling of the co-extrusion machine (not shown) used as well as the ingredients of the shell 22a and/or 22b. Such food product piece shapes can be in the form of pillows, tubes, bars, trapezium, horns, and/or striped products, can be elongate, and can be single packaged for retail sale, can be bulk packaged, etc.

An edible product that preferably is a filling, such as the filling 24a and/or 24b respectively shown in FIGS. 2A and 2B, is formulated in accordance with the present invention to have a matrix that can be in the form of a relatively high viscosity suspension formed of a fat-containing carrier in which reduced-size particles of protein-containing solids having a particle size no greater than about 45 microns are suspended with at least some of the remaining fat-containing carrier having been at least partially absorbed by starch. The filling preferably also includes an emulsifier capable of functioning as a humectant with the total amount of emulsifier added to the filling during the filling making method being greater than what is needed to emulsify the reduced-size particles of protein-containing solids in the fat-containing carrier such that the excess emulsifier functions as a humectant that absorbs water. During an emulsification step when making the filling, the humectant emulsifier coats the reduced-size particles of protein-containing solids functioning as a protectant by providing a protective barrier around the particles of protein-containing solids that can be a thermal barrier and/or water-contact preventing barrier. Excess humectant emulsifier not only absorbs water in the filling, which advantageously minimizes the water activity level of the filling, but it also absorbs water added after the filling is made, such as when the filling is co-extruded when making a multicomponent food product. By acting as a humectant, the humectant emulsifier prevents water from coming into contact with particles of protein-containing solids protecting them and preventing them from denaturing when the filling is subjected to heat and/or pressure.

A preferred humectant emulsifier is lecithin. As is discussed in more detail below, lecithin is added when carrying out a method of making a filling in accordance with the present invention during at least one method step and preferably during a plurality of the filling making method steps. Lecithin is advantageous as it not only functions well as an emulsifier when mixing the particles of protein-containing solids with the fat-containing carrier, it also functions well as a humectant such that any excess remaining in the filling after emulsification functions as a water-absorbing humectant.

A preferred filling formulation includes protein-containing solids in an amount within ±20% of the weight percent of the fat-containing carrier with the particles of the protein-containing solids reduced in size small enough to remain substantially suspended in a matrix formed of starch and fat-containing carrier when enough starch is added to absorb substantially all of the carrier remaining free fat-containing carrier. One preferred filling formulation includes protein-containing solids mixed with a fat-containing carrier in a pre-mix suspension where the weight percent of the protein-containing solids of the pre-mix suspension is within ±20% of the fat-containing carrier of the pre-mix suspension. Another preferred filling formulation includes protein-containing solids mixed with fat-containing carrier in a pre-mix suspension where the weight percent of the fat-containing carrier of the pre-mix suspension is within ±20% of the protein-containing solids of the pre-mix suspension.

Wet particle size reduction of the protein-containing solids in the pre-mix suspension is performed to reduce the particle size of the solids to a size less than 45 microns and preferably no greater than about 40 microns such that the reduced-size particles of the protein-containing solids will be better emulsified by the lecithin enabling the protein-containing solids to remain suspended in a matrix formed of starch and the fat-containing carrier of the filling when enough starch is added to absorb substantially all of the available or free fat-containing carrier during the making of the filling. As is discussed in more detail below, wet particle size reduction is performed on a pre-mix suspension formed when the fat-containing carrier and the protein-containing solids are mixed together with a sufficient amount of lecithin to substantially simultaneously emulsify particles of the protein-containing solids as they are undergoing particle size reduction during a particle size reduction step and being mixed together in a pre-mix step performed substantially simultaneously during the particle size reduction step.

A filling formulated in accordance with the present invention can and preferably does include an amount of lecithin sufficient to facilitate not only particle size reduction but which also functions as (1) an emulsifier during manufacture of the filling, and (2) a protectant during manufacture that continues to act as a protectant within the filling once making of the filling is completed. A preferred filling formulation therefore preferably contains enough lecithin to emulsify; it contains more lecithin than needed for emulsification so that at least some lecithin remains available to function as a protectant that protects proteins within the filling. In such a preferred filling formulation, lecithin functions as (1) an emulsifier that emulsifies the protein-containing solids being mixed in the fat-containing carrier while the particles of the protein-containing solids are being comminuted in a wet particle size reduction step to reduce their size to thereby help to suspend the reduced-size particles of the protein-containing solids in the fat-containing carrier, and (2) a humectant by the remaining lecithin absorbing water preventing water from contacting the protein-containing solids.

In functioning as a protectant, the lecithin does so by the excess not needed for emulsification acting as a humectant that absorbs moisture before the moisture can come into contact with any protein of the reduced-size particles of the protein-containing solids in the filling thereby preventing moisture from drying out proteins. The lecithin also functions as a protectant by providing a protective coating around the reduced-size protein contain solid particles that help prevent oil in the starch-oil matrix or suspension of the filling from coming into contact with any protein. Such a protective function of lecithin is provided by adding significantly more lecithin than the 0.3% to 0.5% by filling weight of lecithin typically used in filling applications so that there is enough lecithin free after emulsification to not only coat the reduced size protein containing solid particles but also to provide free lecithin that acts as a humectant.

The protectant effect of lecithin within the filling advantageously remains available during subsequent food processing performed using the filling that can subject the filling to heat, pressure, moisture, or a combination thereof. For example, where the filling is co-extruded within an outer shell in making a multicomponent food product, lecithin within the filling helps protect proteins within the filling from denaturing when subjected to the relatively high temperatures and pressures the filling undergoes during co-extrusion. Where moisture is added, such as when moisture is added during co-extrusion to facilitate co-extrusion, lecithin also acts as a protectant by preventing moisture from contacting proteins in the filling and drying them out. The protective effect of adding an amount of lecithin greater than needed to achieve emulsification of the size-reduced particles of the protein-containing solids does not stop there as it also protects proteins in the filling during drying and/or baking of the multicomponent food product whether or not the multicomponent food product has been co-extruded.

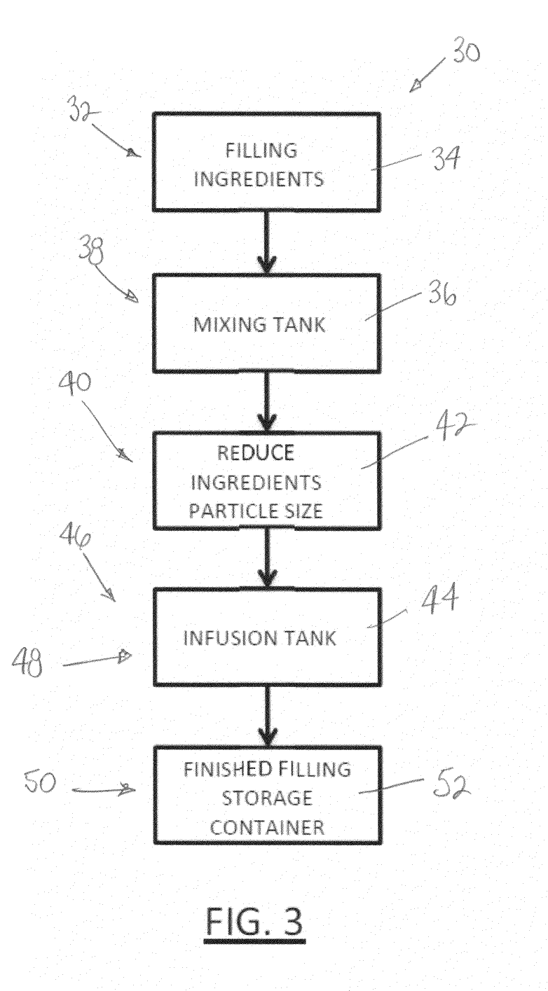

A diagram illustrating a preferred method of making a filling 30 in accordance with the present invention is shown in FIG. 3. In a pre-mix suspension filling ingredients step 32, filling ingredients 34 that include at least one lipid or fat-containing oil and/or at least one lipid or fat-containing shortening are added to a mixer, such as a mixing tank 36, and mixed together in a mixing step 38 to produce a fat-containing carrier that preferably is in the form of a flowable or pumpable liquid that has a viscosity greater than one. The filling ingredients used to produce the fat-containing carrier may need to be heated to a temperature between room temperature and 110° F. before and/or during the mixing step 38. In one preferred method implementation, the pre-mix suspension filling ingredients 34 used to make the fat-containing carrier are heated to a temperature above room temperature that is between room temperature and about 105° F. to soften them sufficiently to facilitate mixing and to enable pumping. In one such preferred implementation, the pre-mix suspension filling ingredients 34 are heated to a temperature between about 75° F. and about 105° F.

In one preferred filling making method implementation, protein-containing solids are added to the mixer, e.g, mixing tank 36, and mixed together with the oil(s) and/or shortening(s) that form the fat-containing carrier during the mixing step 38 such that the protein-containing solids and fat-containing carrier define a pre-mix suspension the mixing step 38 is completed. An emulsifier that preferably is lecithin is also added to the mixer, e.g., mixing tank 36, during the mixing step 38 and is used to help emulsify the protein-containing solids being mixed with the fat-containing carrier during the mixing step 38. An amount of lecithin sufficient to emulsify the protein-containing solids in the oil(s) and/or shortening(s) of the fat-containing carrier is added to the mixer, e.g., mixing tank 36, during the mixing step 38.

In a preferred implementation, the amount of lecithin added during the mixing step is at least an amount sufficient to emulsify the protein-containing solids during the mixing step 38 with the amount of lecithin added during the mixing step 38 being selectively varied or regulated to achieve both emulsification and viscosity control to help produce a pre-mix suspension that is flowable or pumpable when the mixing step 38 is completed. In one such preferred filling making method implementation, between 0.1% and 0.4% lecithin by weight of the pre-mix suspension is added during the mixing step 38. In another such preferred implementation, between about 0.15% and about 0.35% lecithin by weight of the pre-mix suspension is added during the mixing step 38. In a still further preferred implementation, between 0.2% and 0.3% lecithin is added by weight of the pre-mix suspension during the mixing step 38.

The pre-mix suspension is transferred, preferably by pumping, to a comminution apparatus that is a particle size reducer in a particle size reduction step 40 that reduces the size of the particles of the ingredients 42 mixed with the fat-containing carrier during the mixing step 38 so that more than half of the particles are reduced to a size less than 45 microns and preferably no greater than 40 microns. During the particle size reduction step 40, particles of protein-containing solids in the pre-mix suspension are particle size reduced by the particle size reducer so that more than half of the particles of protein-containing solids are reduced to a size less than 45 microns and preferably no greater than 40 microns. In one preferred implementation, the particles of protein-containing solids in the pre-mix suspension are particle size reduced by the particle size reducer during the particle size reduction step 40 so that at least three-quarters of the particles of protein-containing solids are reduced to a size less than 45 microns and preferably no greater than 40 microns. In still another preferred implementation, the particles of protein-containing solids in the pre-mix suspension are particle size reduced by the particle size reducer during the particle size reduction step 40 until substantially all of the particles of protein-containing solids are reduced to a size less than 45 microns and preferably no greater than 40 microns. Samples are taken during the particle size reduction step 40 to determine when the desired amount of particle size reduction has been achieved. If desired, an additional amount of lecithin can be added during the particle size reduction step 40 to help emulsify particles of the protein-containing solids being particle size reduced as well as to help provide viscosity control of the pre-mix suspension to facilitate particle size reduction, emulsification, and/or flowability of the pre-mix suspension. When such an additional amount of lecithin, the total amount of lecithin added preferably does not exceed the maximum amount added to the pre-mix suspension disclosed above.

In another preferred filling making method implementation, protein-containing solids can be introduced into the fat-containing carrier during the wet particle size reduction step 40 along with lecithin in the weight percent amounts or ranges disclosed above to reduce the size of the particles of the protein-containing solids to have a size, size range or size distribution in accordance with that disclosed in the preceding paragraph. In one preferred implementation, the particles of protein-containing solids in the pre-mix suspension are particle size reduced by the particle size reducer during the particle size reduction step 40 so that at least one-half of the particles of protein-containing solids are reduced to a size less than 45 microns and preferably no greater than 40 microns. In another preferred implementation, the particles of protein-containing solids in the pre-mix suspension are particle size reduced by the particle size reducer during the particle size reduction step 40 so that at least three-quarters of the particles of protein-containing solids are reduced to a size less than 45 microns and preferably no greater than 40 microns. In still another preferred implementation, the particles of protein-containing solids in the pre-mix suspension are particle size reduced by the particle size reducer during the particle size reduction step 40 until substantially all of the particles of protein-containing solids are reduced to a size less than 45 microns and preferably no greater than 40 microns.

Where the size reduced particles of protein-containing solids mixed with the fat-containing carrier to form the pre-mix suspension have a particle size ranging between about 25 microns and 40 microns, a diglyceride that preferably includes or is a mono-diglyceride is added either during the mixing step 38 and/or during the particle size reduction step 40 to help keep oil(s) in the pre-mix suspension and/or filling 20 from separating out. Where diglycerides are added, between 0.1% and 0.65% by weight of mono-diglycerides are added. Where the size reduced particles of protein-containing solids mixed with the fat-containing carrier to form the pre-mix suspension have a particle size ranging between about 0.1 microns and 25 microns, no diglycerides or mono-diglycerides are needed.

In a preferred filling making method, a preferred particle size reducer used to reduce the size of the particles of protein-containing solids mixed in the fat-containing carrier is a ball mill. When carrying out the wet particle size reduction step 40 by ball milling, the protein-containing solids preferably are added to the fat-containing carrier transported, typically by pumping, from the mixing tank 36 to the ball mill along with lecithin sufficient to emulsify the particles of protein-containing solids undergoing particle size reduction while being mixed with the fat-containing carrier.

In one such preferred filling making method implementation, between 0.1% and 0.4% lecithin by weight is added to the ball mill during the particle size reduction step 40. In another such preferred implementation, between about 0.15% and about 0.35% lecithin by weight is added to the ball mill during the particle size reduction step 40. In a still further preferred implementation, between 0.2% and 0.3% lecithin is added by weight to the ball mill during the particle size reduction step 40. The amount of lecithin added can be added not only to emulsify but also to help provide viscosity control during the particle size reduction step 40.

After the particle size reduction step 40 is completed, the reduced size particles of protein-containing particles mixed, emulsified, and suspended in the fat-containing carrier form a pre-mix suspension that is transferred to another mixer that can be an infusion tank 44 where a second filling ingredient adding step 46 is performed to add starch and additional lecithin before performing a second mixing step 48 to form the final filling mixture. An amount of starch is added during the second mixing step 48, as discussed in more detail below, sufficient to absorb at least some and preferably substantially all of the fat-containing carrier not in suspension with reduced size particles of protein-containing solids to form a filling matrix that is soft and stable. The starch acts as a sponge to absorb the lipids or fats of the free fat-containing carrier to substantially completely lock up all of the oil or fat in the filling helping to keep the oil or fat from separating out during filling storage while also preventing oil or fat migration during multicomponent food product manufacture with the filling.

An amount of lecithin also is added during the second mixing step 48 so that the total amount of lecithin in the final filling mixture has a weight percent of no greater than 3% and preferably no greater than 2.6%. In one preferred filling making method implementation, an additional amount of lecithin is added during the second or final mixing step 48 such that the resultant filling produced has no more than about 2.5% lecithin by total filling weight. The additional lecithin added during the second of final mixing step advantageously acts as a humectant helping to absorb substantially all of the free water in the final filling mixture producing a filling having a minimum of free water having a low water activity. Additional lecithin remains available in the matrix of the filling to absorb water added during multicomponent food product manufacture, such as during co-extrusion, using the filling. This not only keeps water from contacting protein of the protein-containing solids in the filling, it also helps keep free water to a minimum after multicomponent food product manufacture using the filling. This advantageously reduces spoilage, extends shelf life, retains freshness, maximizes filling softness and texture thereby producing a superior filling.

When the second or final mixing step 48 is completed, the final filling mixture forms a filling that can be transferred preferably by pumping from the infusion tank 44 in a packaging step 50 where a plurality of storage containers 52, such as in the form of tubes, pails, tubs, barrels and the like, are filled with the filling and sealed. Thereafter, the filling storage containers can be stored and/or shipped for storage and subsequent use in multicomponent food product manufacture including co-extrusion using the filling.

With continued reference to FIG. 3, in another preferred method of making a filling in accordance with the present invention, protein containing solids are mixed in a mixer in a pre-mix step with a fat containing carrier to form a pre-mix suspension before particle size reduction is carried out in a particle size reduction step using a particle size reducer to reduce the size of the protein containing solids carried by the carrier. The pre-mix mixer can be a conventional mixing tank, such as a commercially available conventional food mix tank or the like used in commercial food preparation and/or processing applications. The particle size reducer can be a grinding machine, a milling machine, or another type of particle size reducer such as discussed in more detail below.

In one implementation of a method of making the filling, a viscosity control agent can be added to the pre-mix suspension (a) during the pre-mix step, (b) during the particle size reduction step, or (c) during both the pre-mix step and the particle size reduction step. For example, in one implementation, a relatively small amount of the viscosity control agent, typically less than 5% by weight of the total pre-mix suspension, is added to the pre-mix suspension during the pre-mix step where mixing in the pre-mix mixer is being performed to impart to the pre-mix suspension a desired viscosity falling within a suitable viscosity range desired for particle size reduction. Depending on the type of protein containing solids, the ratio of solids to carrier, the production rate or volumetric flow rate of the pre-mix suspension sought to be particle size reduced, and other factors, an additional amount of the viscosity control agent can be added to the pre-mix during particle size reduction as needed to facilitate smooth operation in the particle size reducer as well as smooth flow through the particle size reducer (where particle size reduction can be done in a continuous flow process as opposed to a batch process). In a preferred implementation, the amount of viscosity control agent added to the pre-mix suspension, either at the pre-mix mixing tank and/or at or upstream of the particle size reducer, is regulated in response to changes of the viscosity of the pre-mix suspension undergoing particle size reduction and/or changes in the production rate or flow rate through the particle size reducer. In one preferred implementation, the amount of viscosity control agent in the pre-mix suspension varies between 0.1% and 1% by weight of the total weight of the pre-mix suspension.

An emulsifier can also be added to the pre-mix suspension (a) during the pre-mix step, (b) during the particle size reduction step, or (c) during both the pre-mix step and the particle size reduction step. Where an emulsifier is added to the pre-mix suspension, it is done to facilitate emulsification of the protein containing solids within the fat containing carrier to help promote more efficient mixing of the pre-mix suspension. The inclusion of an emulsifier also helps facilitate emulsification of the protein containing solids within the carrier during particle size reduction.

In one preferred filling manufacturing method implementation, a single component that can function as both a viscosity control agent and an emulsifier is added to the pre-mix suspension (a) during the pre-mix step, (b) during the particle size reduction step, and/or (c) during both the pre-mix step and the particle size reduction step. One preferred component that provides both emulsification and viscosity control is lecithin with the amount of lecithin added being dependent on the amount of emulsification of the solids within the carrier desired as well as the amount that the viscosity of the pre-mix suspension needs to be increased or decreased during particle size reduction. The use of lecithin to regulate viscosity can play an important role during the startup of the particle size reduction step in achieving a desirably stable flow rate or production rate as well as enabling the flow rate or production rate to be increased until a suitably high flow rate or production rate necessary for commercial filling production is achieved. One preferred type of lecithin particularly well suited for use in making a filling in accordance with the present invention is a soy lecithin.

Where lecithin is added to the pre-mix suspension, lecithin constitutes no more than 10% of the total weight of the pre-mix. The pre-mix suspension includes at least a trace amount of lecithin that can vary between about 0.1% and about 1% by weight of the total weight of the resultant filling produced. In another preferred implementation, the amount of lecithin in the pre-mix suspension varies between 0.1% and 1% of total filling weight. In one preferred implementation, the pre-mix contains about 0.5% lecithin (0.5%±10%). As previously indicated, particle size reduction can be monitored with the amount of lecithin added to the pre-mix suspension being varied in response to monitoring particle size reduction to achieve a suitable pre-mix suspension viscosity or viscosity range that optimizes the volumetric flow rate or production rate of pre-mix suspension being particle size reduced.

The carrier used in the pre-mix preferably is a fat containing oil, a fat containing shortening, and can be a combination of a fat containing oil and a fat containing shortening that is flowable and/or which can become flowable during the pre-mixing step. Examples of suitable fat containing oils and shortenings include vegetable oils and/or vegetable shortenings, such as olive oil, palm oil, coconut oil, palm kernel oil, soybean oil, canola oil, corn oil, sunflower oil, safflower oil, peanut oil, sesame oil, grape seed oil, ghee, pumpkin seed oil, almond oil, cottonseed oil, walnut oil, mustard oil, and/or another type of vegetable oil or shortening. It is contemplated that the carrier can be or include at least some animal fat based oil or shortening, e.g., lard, depending on factors that include the type of filling sought to be produced, post processing exposure to high temperatures, etc.

The protein containing solids used in the pre-mix suspension include protein containing bulking agents typically used in edible food products, dried or powdered solids of an edible material containing globular proteins, as well as solids containing fibrous proteins. Examples of suitable protein containing solids include whey powder, soy powder, cocoa powder, nonfat dry milk, yogurt powder, milk powder, and other types of relatively high protein edible food products typically available in a dried or powdered form. Other suitable protein containing solids include whey protein isolate, dried or powdered eggs, as well as any other type of dried or powdered beans, including e.g., garbanzo beans, falafel, miso, white beans, yellow beans, lentils, kidney beans, black beans, tofu, split peas, chick peas, hummus, cowpeas, lima beans, and the like. Other meat or fish based sources of protein containing solids can also be used. Examples include powdered fish meal, fish protein powder, powdered beef, and other powdered meats.

In one preferred method of making a filling, pink slime or lean finely textured beef, is mixed with the fat containing carrier during the pre-mixing step with the resultant pre-mix suspension being particle size reduced as described herein. A filling produced in accordance with the present invention using pink slime or lean finely textured beef can be used to make animal food products, including cat food, dog food, and the like.

The pre-mix suspension includes protein containing solids mixed in a flowable fat containing carrier in a conventional mixer that can be a commercially available bulk mixing tank or another type of mixer used to mix large amounts commonly used in commercial or industrial food production and food processing applications. An initial pre-mix containing a substantially greater amount of the carrier relative to the amount of solids can be initially used during startup of the particle size reduction process with subsequent pre-mix formulations reducing the amount of carrier relative to the amount of solids until or when a relatively stable flow at a desirably high flow rate is achieved. Once stable flow through the particle size reducer at a desirably high flow rate is achieved, a pre-mix suspension formulation containing a weight percent of solids that is within ±25% of the weight percent of the carrier is used along with no more than about 1% lecithin and preferably about 0.5% lecithin.

In one preferred pre-mix formulation, the amount of protein containing solids is proportional to the amount of the carrier with the amount of the solids relative to the amount of the carrier varying no more than about ±30% (and/or vice versa). The pre-mix includes a suitable amount of lecithin that will not exceed 1.5% total filling weight and that preferably ranges between 0.1% and 0.7% of total filling weight. In one such preferred pre-mix formulation, the pre-mix has about 0.5% lecithin by total filling weight.

In another preferred pre-mix suspension formulation, the amount of solids is roughly equal to the amount of the carrier with the amount of the solids relative to the amount of the carrier varying no more than about ±25% (and/or vice versa). The pre-mix includes a suitable amount of lecithin that will not exceed 5% total pre-mix weight and that preferably ranges between 0.1% and 3% of total pre-mix weight. In one such preferred pre-mix formulation, the pre-mix suspension has between about 1% and 1.5% lecithin by total pre-mix weight.

In still another preferred pre-mix suspension formulation, the amount of solids is substantially equal to the amount of the carrier with the amount of the solids relative to the amount of the carrier varying no more than about ±15% (and/or vice versa). The pre-mix includes a suitable amount of lecithin that will not exceed 5% total pre-mix weight and that preferably ranges between 0.4% and 3% of total pre-mix weight. In one such preferred pre-mix formulation, the pre-mix has about 0.5% lecithin by total pre-mix weight. Another such pre-mix formulation has about 0.75% lecithin by total pre-mix weight. Still another such pre-mix formulation has about 1% lecithin by total pre-mix weight. A still further pre-mix formulation has between about 1.25% and 1.75% lecithin by total pre-mix weight.

In a further preferred pre-mix formulation, the pre-mix contains about 55% solids (55% solids±15%), about 45% carrier (45% carrier±15%), and between 0.1% and 0.7% lecithin by pre-mix weight. In one such preferred pre-mix formulation, the pre-mix contains about 58% solids and about 42% carrier with the remainder including lecithin ranging between 0.1% and 0.7% (preferably about 0.5%) of pre-mix weight.

Where the filling is intended to be a confectionary filling, the pre-mix includes enough sugar mixed during the pre-mix mixing step to produce a confectionary filling. In one preferred confectionary filling formulation, the pre-mix includes between 20% and 50% by weight of the total weight of the pre-mix. In another preferred confectionary filling formulation, the pre-mix includes between 20% and 50% by weight of the total weight of the filling.

A filling produced in accordance with the present invention will have a final fat percentage ranging between about 25% and 50% and preferably between 28% and 40%. Where salt is added, the resultant filling preferably contains no than about 1% salt by weight and preferably between 0.5% and 1% salt by total weight of the filling. Where the filling is a savory filling that lacks any sugar, the result filling can contain no salt and preferably contains no more than about 0.1% salt by total filling weight. It should be made clear that salt is not required to produce a filling in accordance with the present invention as the present invention contemplates fillings produced without any salt and/or which contains no salt.

Once the pre-mix step is completed, the pre-mix suspension is then transferred, such as via a transfer pump, to a particle size reducer that reduces the size of the protein containing solids mixed in the carrier so the particles are reduced in size enough so they will not settle out of a filling made in accordance with the present invention even when stored for at least six months and even during subsequent food processing operations, e.g., co-extrusion, using the filling. In the particle size reduction step, the particle size of the protein containing solids entrained in the flowable carrier is reduced by the particle size reducer to a size less than 40 microns so the reduced size particles of the protein containing solids will remain suspended within the resultant filling while in storage for at least six months as well as during co-extrusion. In a preferred method of making a filling in accordance with the present invention, the particle size reduction step preferably is a cold processed step conducted at a temperature of less than 130 degrees Fahrenheit that prevents denaturing of the proteins in or of the solids.

During particle size reduction, the protein containing solids entrained within the flowable carrier are subjected to one or more of pressure, shear, crushing and/or grinding forces for enough time to reduce the size of the particles of the solids so that substantially all of the solid particles have a size of 40 microns or smaller. In one preferred particle size reduction step, the solid particles are processed by the particle size reducer while carried by the carrier until more than 50% of the particles have a size of between 10 microns and 30 microns with substantially all of the particles having a particle size smaller than 40 microns. In another preferred particle size reduction step, the solid particles are processed by the particle size reducer while carried by the carrier until more than 75% of the particles have a size of between 10 microns and 30 microns with substantially all of the particles having a particle size smaller than 40 microns. In still another preferred particle size reduction step, the solid particles are processed by the particle size reducer while carried by the carrier until more than 80% of the particles have a size of between 10 microns and 30 microns with substantially all of the remaining particles having a particle size smaller than 40 microns.

In one preferred particle size reduction step, particle size reduction is performed until substantially all of the particles have a particle size between 10 microns and 40 microns. In another preferred particle size reduction step, particle size reduction is performed until substantially all of the particles have a particle size between 10 microns and 30 microns. In still another preferred particle size reduction step, particle size reduction is performed until substantially all of the particles have a particle size between 10 microns and 30 microns with at least a majority of the particles having a size of 15 microns or smaller. In a further preferred particle size reduction step, particle size reduction is performed until substantially all of the particles have a size of between 20 microns and 30 microns. In a still further preferred particle size reduction step, particle size reduction is performed until substantially all of the particles have a size of between 10 microns and 20 microns. In another preferred particle size reduction step, particle size reduction is performed until substantially all of the particles have a size of less than 20 microns. In still another preferred particle size reduction step, particle size reduction is performed until substantially all of the particles have a size of no bigger than about 15 microns. In still another preferred particle size reduction step, particle size reduction is performed until substantially all of the particles have a size of no bigger than about 25 microns.

One preferred particle size reducer suitable for use in performing particle size reduction in carrying out a method of making a filling in accordance with the present invention is a ball mill. Such a ball mill can be generally horizontal or vertical having a generally cylindrical chamber that functions as a grinding chamber that is at least partially filled with grinding media, such as hardened steel balls, ceramic beads, or the like, in which the pre-mix suspension is pumped. During operation, the grinding media is moved relative to the drum comminuting the particles of the solids in the carrier grinding them into smaller sized particles. The ball mill is operated until a desired maximum solid particle size or acceptable particle size range is achieved in accordance with that discussed above. Depending on the construction of the ball mill, a ball mill suitable for use as a particle size reducer in practicing a method of making a filling in accordance with the present invention can be of batch operated construction or of substantially continuous flow construction.

One preferred type of ball mill suitable for use is a commercially available ball mill of the type used for chocolate making. Such ball mill has a generally cylindrical grinding chamber substantially filled with grinding media in which the pre-mix suspension is comminuted to reduce the particle size of the solids in the carrier. During operation, a pump transfers the pre-mix suspension from the pre-mix mixing tank to the ball mill where the solids are comminuted between the moving grinding media. Where the ball mill is a horizontal ball mill, the cylinder that forms the grinding chamber can be rotated to cause the grinding media to move around, e.g., roll or tumble, within the chamber comminuting the solid particles while doing so and/or can employ a rotating shaft, e.g., agitator or stirrer, which also moves the grinding media (and can also stir the pre-mix suspension). Where the ball mill is a generally vertical ball mill, a rotating shaft within the drum moves the grinding media to grind or comminute the solid particles in the carrier into smaller particles. A pump recirculates the pre-mix suspension within the ball mill until the desired maximum particle size or range of suitable particle sizes is achieved.

During ball mill operation, the pre-mix suspension is pumped into the grinding chamber of the ball mill and comminuted between the moving grinding media, any stirrer disposed within the chamber, and the grinding chamber wall via compression and shear causing particle size reduction of the protein containing solids. While some melting can occur during comminuting, temperature control can be provided in the form of one or more cooling jackets that cool the ball mill enabling particle size reduction to be carried out in a cold processing step that advantageously prevents denaturing or breakdown of proteins in the pre-mix suspension during particle size reduction.

A ball mill is particularly well suited for performing particle size reduction of the protein containing solids in pre-mix suspension formulations in accordance with those described above because it can be used to reduce particle size(s) in pre-mix suspensions formulated to make nearly any kind of a filling in accordance with the present invention. More specifically, a ball mill is well suited for use in reducing the particle size of protein containing solids of not just savory filling pre-mix suspensions but also confectionary filling pre-mix suspensions that contain a substantial amount of sugar. Examples of ball mills suitable for use in performing the particle reduction step include a chocolate compound ball mill made by Savage Brothers, Co. of Elk Grove Village, Ill., a Nagema 292C ball mill having a production capacity of up to 1250 kilograms per hour, a Netzsch vertical ball mill type KE from NETZSCH-Feinmahltechnik GmbH of Sedanstraβe 70, 95100 Selb, Germany, and/or a Packint SOTU100, SOTU180, SOTU300, SOTU600 or SOTU1000 ball mill from Packint Chocolate Equipment of via Cappelletta 88, Borgo Priolo, Italy.

Another preferred particle size reducer suitable for use in performing particle size reduction in carrying out a method of making a filling in accordance with the present invention is a roll refiner. Such a roll refiner has at least a plurality of elongate rolls that rotate during comminuting of the pre-mix suspension to reduce the particle size of the protein containing solids in the carrier of the pre-mix suspension by controlling the gap between adjacent refining rolls, the pressure applied by the rotating rolls, the speed at which one or more of the rolls rotate, and other factors. The pressure and the shearing action imparted by adjacent rotating rolls on the particles of protein containing solids in the pre-mix suspension comminute the solids into smaller particles.

One preferred roll refiner is a five roll refiner having five elongate rotary rolls with a pair of rolls through which the pre-mix suspension is first refined disposed at the bottom with the three remaining rolls of the refiner extending vertically generally upwardly with one of these three rolls overlying one of the first two rolls. Where a roll refiner is used, it can be used with a pre-refiner employing a pair of rolls through which the pre-mix suspension first passes before entering the five roll refiner. An example of a roll refiner suitable for use in performing the particle reduction step include a Finer G 1300/1800/2500 five roll refiner from Buhler AG of Gupfenstrasse 5, 9240 Uzwil, Switzerland that can be used with a Buhler pre-refiner such as a Buhler PreFiner D, PreFiner G or PreFiner M two roll pre-refiner.

In a preferred method of particle size reduction using a roll refiner, only a single roll refiner having at least a plurality of pairs, i.e. at least three, refining rolls, is used. In another preferred method of particle size reduction using a roll refiner, a bank of roll refiners having at least a plurality of pairs, i.e. at least three, refining rolls, can be used. In a currently preferred particle size reduction method using a roll refiner, five roll refiners are preferably used.

During particle size reduction using a roll refiner, the pre-mix suspension is fed into the roll refiner where the rotating rolls apply pressure and cause shear comminuting the particles of protein containing solids in the suspension causing them to be reduced in size. The pre-mix suspension can be recirculated as needed a plurality or more times through the roll refiner until a desired maximum particle size is achieved and/or until a desired particle size range or distribution is obtained.

In another method of particle size reduction, a dry grinder is used to reduce the particle size of the protein containing solids until a desired maximum particle size is achieved or suitable range of particle sizes is obtained. In a preferred particle size reduction step, the pre-mix suspension is processed by the dry grinder to reduce the particle size of the protein containing solids in the carrier. Where a dry grinder is used to perform particle size reduction of a pre-mix suspension of protein containing solids in a fat containing oil or shortening carrier, sugar preferably is added to the pre-mix suspension to prevent plugging or blinding of screens within the dry grinder. As such, dry grinders are preferably only used to perform particle size reduction in making a confectionary filling in accordance with the present invention.

After the particle size reduction step has been completed, the particle size reduced (refined) pre-mix suspension is transferred, such as via another transfer pump, to a final filling mixing tank where another mixing step is carried out to mix starch with the refined pre-mix suspension to produce a filling matrix in which the reduced size protein containing solid particles will become suspended. The starch is mixed in this filling matrix mixing step until it absorbs at least some and preferably substantially all of the fat containing carrier that is free and available in the refined pre-mix. In a preferred implementation of a method of making a filling in accordance with the present invention, the amount of starch added to the refined pre-mix during the filling matrix mixing step is enough to absorb substantially all of the free or available fat containing carrier, e.g., oil and/or shortening, in forming a filling matrix in which the reduced size particles of protein containing solids will remain suspended in the final filling produced. Trial and error along with routine experimentation may be done to determine the weight percent or amount of starch that must be added to absorb substantially all of the free or available oil or shortening carrier during the filling matrix mixing step.

While a conventional mixing tank can be used that uses a beater, agitator, paddles and/or other means to agitate and/or stir to mix the starch with the refined pre-mix during the filling matrix mixing step, an infusion tank can also be used that relatively mildly agitates the filling mixture to agglomerate the starch in mixing the starch until the starch absorbs substantially all of the fat containing carrier free or available in the filling mixture for absorption. An example of a conventional mixer or mixing tank in which this mixing step can be performed is a Walker Multimixer PZ-CB-MM having a cone bottom with a center outlet available in 10 gallon, 25 gallon, 50 gallon, 100 gallon, 200 gallon, 300 gallon, 400 gallon, 500 gallon and 600 gallon mixing tank capacities from Walker Engineered Products of 625 State Street, New Lisbon, Wis. Such a commercially available mixer or mixing tank can be configured with a bottom mounted agitator that can be rotated during the mixing and can include a scraper blade agitator assembly that continuously wipes the side wall and/or bottom of the mixing tank during operation.

In a preferred filling formulation, the starch is a flour that preferably is an unrefined flour to maximize the amount of the fat containing carrier that is absorbed by the starch when added during the filling matrix producing mixing step. Preferred flours suitable for use in making a filling in accordance with the present invention includes potato flour, wheat flour, corn flour, rice flour, buckwheat flour, and/or rye flour.

In order to help facilitate carrier absorption and to create a matrix in which the reduced size protein containing particles remain suspended in the filling, the flour has a mesh size of at least 30 mesh and preferably between 50 mesh and 100 mesh. In one preferred filling formulation, starch in the form of a flour having a mesh size of about 80 mesh (80 mesh±10%) is added and mixed during the filling matrix mixing step. Using such a relatively small mesh size flour not only facilitates carrier absorption, it also produces a filling matrix in which the reduced size protein containing solid particles are suspended that is soft, of smooth consistency, and which can be creamy.

In a preferred filling formulation, no more than about 35% starch, e.g., flour(s), by weight is added. In another preferred filling formulation, the amount of starch, e.g., flour(s), makes up no more than 30% by weight of the total filling weight. In another preferred embodiment, starch is added during the final mixing step in an amount that produces a filling having between 3% and 25% starch by weight. In still another preferred embodiment, starch is added during the final mixing step in an amount that produces a filling having between 5% and 15% by weight. In one currently preferred embodiment, starch, e.g., flour(s), is added during the final mixing step in an amount that produces a filling having between 5% and 10% by weight. Using unrefined flour having such mesh sizes and/or ranges causes the flour to act as a polymer in absorbing the flowable carrier, e.g., oil, in producing the filling matrix in which the reduced size protein containing particles are suspended.

Additional lecithin is also added to the refined pre-mix suspension to coat the reduced size protein containing solid particles to protect them in the manner described above. The additional lecithin not only helps with emulsification in helping to more uniformly and homogenously suspend the reduced size particles within the filling matrix, it also coats or wets the reduced size particles helping to protect them. The lecithin coating protects the proteins by keeping them from denaturing, protects the proteins from drying out, and protects the proteins from coming into contact with fat in the matrix including fat that may have migrated out of the matrix (such as during co-extrusion). The lecithin also functions as a humectant that absorbs moisture minimizing the amount of free or available water in the filling so the resultant filling has a water activity level of less than 0.5% such that bacterial growth is substantially completely prevented without the addition of any preservatives to the filling.

In a preferred method of making a filling in accordance with the present invention, lecithin is added to the final filling mixing tank and mixed with the pre-mix suspension until substantially all of the reduced size protein containing particles are wetted or otherwise coated with lecithin in a particle wetting or coating step. In a preferred filling making method, at least some lecithin is added to the final filling mixing tank before the starch is added. In another preferred filling making method, the lecithin is added to the final filling mixing tank and mixed with the pre-mix suspension for enough time to coat or wet substantially all of the reduced size particle in the particle coating step before the starch is added to the same final filling mixing tank in the filling matrix mixing step.

For example, in one preferred final filling mixing step, the lecithin is added the particle size reduced pre-mix in the mixer and the mixer operated for enough time in carrying out the particle wetting step before the addition of the starch to enable the lecithin to coat and wet the reduced size particles of protein containing solids. After the mixer has been operated long enough to adequately mix the lecithin so it coats and/or wets the reduced size particles of protein containing solids, the starch is added and the mixer operated in carrying out the filling matrix mixing step until the starch has absorbed substantially all of the free or available carrier entrapping the fat in the carrier in the resultant matrix or suspension of the filling that is formed when mixing is completed.

An amount of lecithin is added during the final filling mixing step that brings the total weight percent of lecithin in the filling of no greater than 5%. In a preferred filling formulation, an amount of lecithin is added to produce between 1% and 3% lecithin in the filling by weight. In another preferred filling formulation, an amount of lecithin is added to produce a filling having between 2% and 3% lecithin by weight. In one preferred filling formulation, an amount of lecithin is added that results in the filling having about 2.5% lecithin by weight.

When the final mixing step is completed, the filling mixture produces a filling in accordance with the invention that is a suspension having a relatively high viscosity of greater than 250,000 centipoise that preferably is greater than 1 million centipoise at room temperature of about 20 degrees Celsius or about 70 degrees Fahrenheit. The filling can be transferred from the final filling mixing tank by a transfer pump or the like to a storage container, such as barrel, drum or the like, in which the filling is gas tightly sealed.

A filling produced in accordance with the invention, maintains reduced size particles of protein containing solids in suspension in the filling. Reducing the particle size of the protein containing solids to a particle size of less than 40 microns increases the total surface area of the protein containing solids within the suspension of the filling which maintains the smaller sized protein containing solid particles in suspension in the starch-fat matrix of the filling more uniformly and stays in suspension longer. The result is a filling in which the protein containing solid particles are more uniformly dispersed throughout the filling and which remain more uniformly dispersed for a longer period of time advantageously increasing filling shelf life.

A filling made in accordance with the present invention possesses improved shelf life despite being formulated with no preservatives. A filling made in accordance with the present invention has no more than 1% water activity and preferably no more than about 0.5% water activity advantageously producing a confectionary or savory filling that is anti-bacterial or nonperishable without the use of any preservative. Such a filling made in accordance with the present invention advantageously can remain stored in a sealed drum or barrel, such as a 55 gallon drum or barrel, for at least six months without any fat migrating out of the filling.

Understandably, the present invention has been described above in terms of one or more preferred embodiments and methods. It is recognized that various alternatives and modifications may be made to these embodiments and methods which are within the scope of the present invention.

What is claimed is:

1. An edible filling comprising a plurality of particles of protein-containing solids, a fat-containing carrier comprised of one of an oil and a shortening, a lecithin, and a starch.

2. The edible filling of claim 1 wherein the protein-containing solids are comprised of a plurality of particles that have a particle size no greater than 45 microns.

3. The edible filling of claim 2 wherein the filling is comprised of no more than 3% lecithin by weight.

4. The edible filling of claim 3 wherein the protein-containing solids are comprised of a plurality of particles that have a particle size no greater than 40 microns.

5. The edible filling of claim 4 wherein the protein-containing solids are comprised of a plurality of particles having a size of between 10 microns and 30 microns.

6. The edible filling of claim 4 wherein the edible filling comprises a savory filling.

7. The edible filling of claim 4 further comprising sugar and wherein the edible filling comprises a confectionary filling.

8. The edible filling of claim 7 wherein the filling comprises between 20% and 50% sugar by weight.

9. The edible filling of claim 4 wherein the plurality of particles of protein-containing solids are suspended in a matrix comprised of the fat-containing carrier and the starch.

10. The edible filling of claim 9 wherein the starch is comprised of a flour.

11. The edible filling of claim 10 wherein the flour comprises one or more of a potato flour, a rice flour, a wheat flour, and a corn flour.

12. The edible filling of claim 11 wherein the flour has a mesh size of no larger than 30 mesh.

13. The edible filling of claim 11 wherein the flour has a mesh size of between 50 mesh and 100 mesh.

14. The edible filling of claim 13 wherein the flour has a mesh size of about 80 mesh±10%.

15. The edible filling of claim 4 wherein the lecithin is comprised of soy.

16. The edible filling of claim 4 wherein the fat-containing carrier is comprised of an oil or a shortening.

17. The edible filling of claim 16 wherein the fat-containing carrier is comprised of a vegetable oil or a shortening comprised of a vegetable fat.

18. The edible filling of claim 1 wherein the protein-containing solids are comprised of a plurality of particles having a particle size no greater than 40 microns, the carrier comprises an oil or shortening containing a vegetable fat, the starch comprises a flour, and the edible filling is disposed in an outer edible shell forming a multicomponent food product.

19. The edible filling of claim 1 comprising 55%±15% protein containing solids, 45%±15% fat containing carrier, and between 1% and 3% lecithin by weight.

20. The edible filling of claim 19 wherein the filling is comprised of between 1.2% and 2.5% lecithin.

21. The edible filling of claim 20 wherein the protein-containing solids are comprised particles having a particle size no greater than 40 microns.

22. The edible filling of claim 21 wherein the protein is comprised of at least one of nonfat dry milk, whey powder and cocoa powder.

23. The edible filling of claim 22 wherein the starch is comprised of flour having a mesh size no less than 30 mesh.
